(19) United States
(12) Patent Application Publication
(10) Pub. No.: US 2015/0032853 A1
(43) Pub. Date: Jan. 29, 2015

(54) COMMUNICATION DEVICE, INFORMATION PROCESSING SYSTEM, AND NON-TRANSITORY COMPUTER READABLE MEDIUM

(71) Applicant: FUJI XEROX Co., Ltd., Tokyo (JP)

(72) Inventor: Nobushige ASAHI, Yokohama-shi (JP)

(73) Assignee: FUJI XEROX CO., LTD., Tokyo (JP)

(21) Appl. No.: 14/217,751

(22) Filed: Mar. 18, 2014

(30) Foreign Application Priority Data
Jul. 26, 2013 (JP) 2013-155365

(51) Int. Cl. H04L 29/06

(52) U.S. Cl. CPC H04L 65/60
USPC 709/219

(57) ABSTRACT

A communication device includes a memory in which representative values are stored, each of the representative values being a representative value of response times of communication with a server using one of multiple routes in a communication line that has the multiple routes, which include multiple relay devices and which are used to access the server, and the representative values being related to at least two of the routes and includes a determining section that determines that, in the case where a difference between the representative values, which are related to the two different routes and which are stored in the memory, is greater than a threshold, one of the relay devices that is a difference between configurations of the two different routes is a delay element.

### CROSS-REFERENCE TO RELATED APPLICATIONS

This application is based on and claims priority under 35 USC 119 from Japanese Patent Application No. 2013-155365 filed Jul. 26, 2013.

### BACKGROUND

(i) Technical Field

The present invention relates to a communication device, an information processing system, and a non-transitory computer readable medium.

(ii) Related Art

An information communication terminal that acquires information from a server device via a network such as the Internet has generally been used. A network is expanded in the form of a mesh by using a branching device such as a router and a network relay device such as a gateway, and one route is selectively used to access a desired server device.

### SUMMARY

According to an aspect of the invention, there is provided a communication device including a memory in which representative values are stored, each of the representative values being a representative value of response times of communication with a server using one of multiple routes in a communication line that has the multiple routes, which include multiple relay devices and which are used to access the server, and the representative values being related to at least two of the routes and a determining section that determines that, in the case where a difference between the representative values, which are related to the two different routes and which are stored in the memory, is greater than a threshold, one of the relay devices that is a difference between configurations of the two different routes is a delay element.

### BRIEF DESCRIPTION OF THE DRAWINGS

An exemplary embodiment of the present invention will be described in detail based on the following figures, wherein:

FIG. 1 is a diagram illustrating an information processing system according to the exemplary embodiment of the invention;

FIG. 2 is a block diagram illustrating the configuration of a communication quality analysis server illustrated in FIG. 1;

FIG. 3 is a block diagram illustrating the configuration of one of information acquisition apparatuses illustrated in FIG. 1;

FIG. 4 is a flowchart describing response time measurement notification processing in the one of the information acquisition apparatuses;

FIG. 5 is a table showing Media Access Control (MAC) addresses of the information acquisition apparatuses illustrated in FIG. 1;

FIG. 6 is a table showing the specific contents of data items that are acquired and transmitted in the response time measurement notification processing illustrated in FIG. 4;

FIG. 7 is a flowchart describing response time storage processing in the communication quality analysis server;

FIG. 8 is a table showing response times that are part of data items, which are recorded in a response time memory, and that correspond to specific routing information items that are measured by the information acquisition apparatuses;

FIG. 9 is a table showing each average value of response times that have the same routing information item, the average values being part of data items, which are stored in the response time memory;

FIG. 10 is a flowchart describing determination processing in the communication quality analysis server;

FIG. 11 is a flowchart illustrating delay route avoidance processing that is an example of processing in one of relay devices that is informed of a delay element; and

FIG. 12 is a flowchart illustrating delay route avoidance processing that is an example of processing in one of the information acquisition apparatuses that is informed of a delay element.

### DETAILED DESCRIPTION

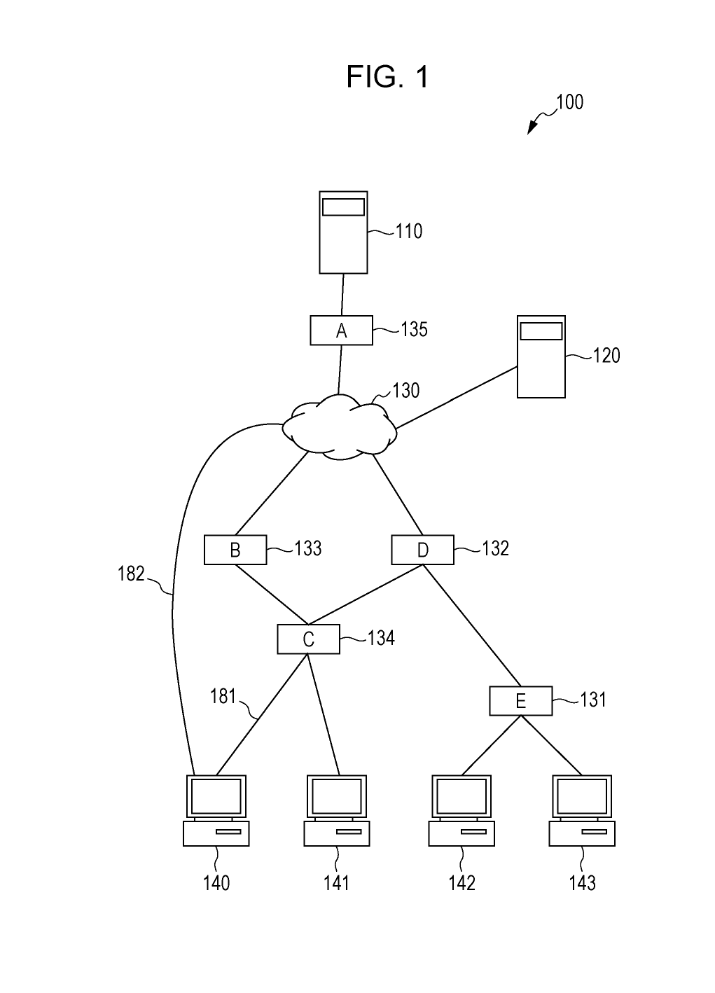

An information processing system 100 according to an exemplary embodiment of the invention is illustrated in FIG. 1. As illustrated in FIG. 1, the information processing system 100 includes a communication network 130 such as the Internet, a server device 110 such as a Web server or a File Transfer Protocol (FTP) server that is connected to the communication network 130 and that outputs an information item in accordance with a request that is received by the server device 110, information acquisition apparatuses (information acquisition sections) 140 to 143 each of which is a terminal that is connected to the server device 110 via the communication network 130, relay devices 131 to 135 such as routers and switches that form routes via which the information acquisition apparatuses 140 to 143 and the server device 110 are connected with the communication network 130, and a communication quality analysis server 120 that is a communication device and that forms an information processing system by which communication quality information items such as communication speeds in communications between the information acquisition apparatuses 140 to 143 and the server device 110 are acquired.

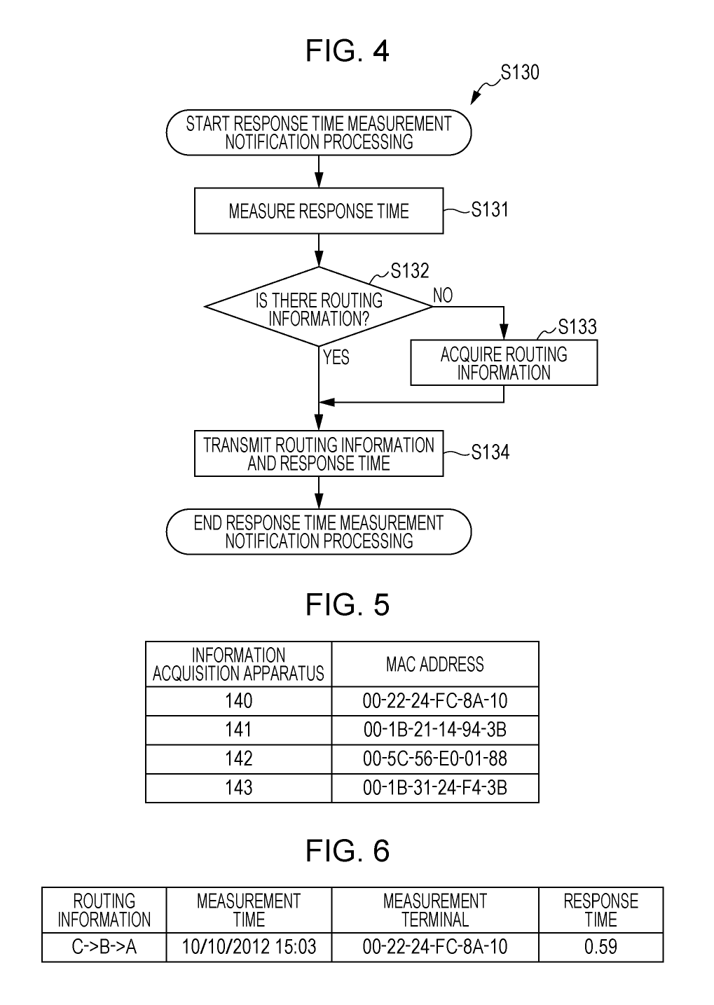

Note that only the information acquisition apparatus 140 is illustrated in FIG. 3 and FIG. 4, and the information acquisition apparatus 140 may be connected to the communication network 130 by using any one of communication 181 and communication 182 that use a different protocol. Similarly, the information acquisition apparatuses 141 to 143 may perform communication using multiple protocols, or all of the information acquisition apparatuses 140 to 143 may only perform communication using a single protocol. Although, in FIG. 1, the relay devices 131 to 135 are illustrated separately from the communication network 130 for the sake of explanation, the relay devices 131 to 135 may be present within the communication network 130. The server device 110, the communication quality analysis server 120, and the information acquisition apparatuses 140 to 143, which are included in the information processing system 100 of the exemplary embodiment, include memory devices such as a central processing unit (CPU), a random access memory (RAM), and a magnetic disk unit, and various processing operations are performed in response to instructions from programs that are recorded in such memory devices.

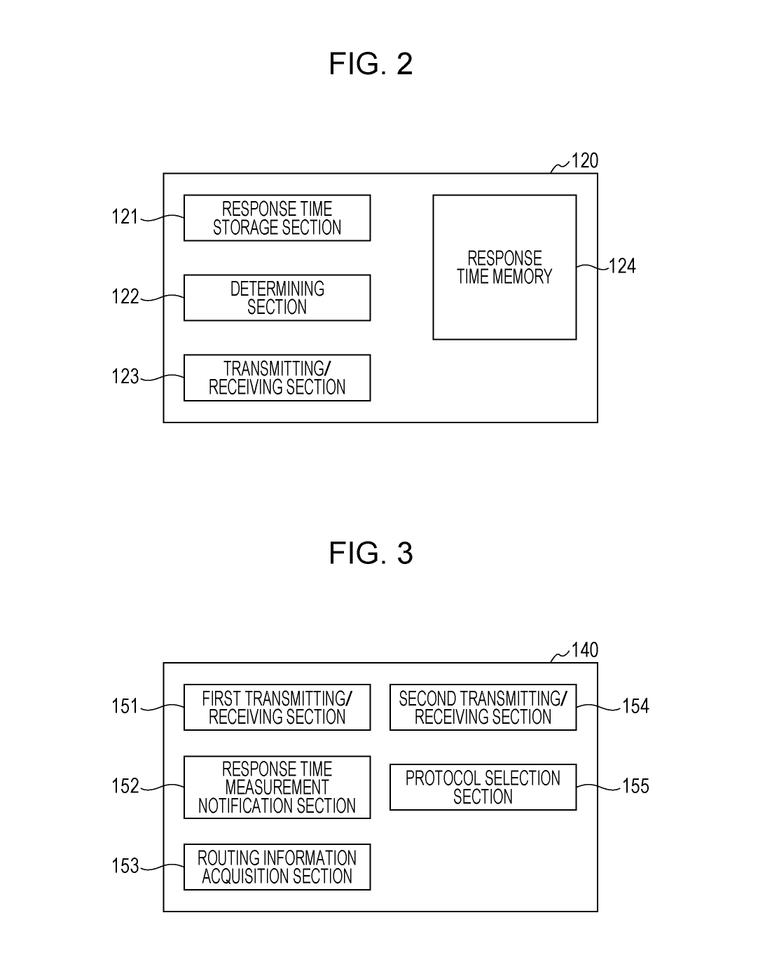

FIG. 2 is a block diagram illustrating the configuration of the communication quality analysis server 120 illustrated in FIG. 1. As illustrated in FIG. 2, the communication quality analysis server 120 includes a transmitting/receiving section 123 that may receive routing information items and response times from the information acquisition apparatuses 140 to 143 and transmit an information item regarding a determined delay element to the relay devices 131 to 135 or the information acquisition apparatuses 140 to 143, a response time memory 124 in which routes which are used when one of the information acquisition apparatuses 140 to 143 and the server device 110 communicate with each other and corresponding response times are recorded, and in which the average value of the response times of each of the routes is recorded as the representative value of the response times, a determining section 122 that determines a delay element on the basis of data items such as routes and response times that are recorded in the response time memory 124, and a response time storage section 121 that records routing information items and response times when the response time storage section 121 is informed of the routing information items and the response times from the information acquisition apparatuses 140 to 143, calculates the average values of response times, and causes the response time memory 124 to store the average values.

FIG. 3 is a block diagram illustrating the configuration of the information acquisition apparatus 140 illustrated in FIG. 1. As illustrated in FIG. 3, the information acquisition apparatus 140 includes a first transmitting/receiving section 151 that is connected with the communication network 130 through the communication 181 using a first protocol, transmits a request message for requesting connection to the server device 110, and receives a response message to the request message from the server device 110, a second transmitting/receiving section 154 that performs communication by connecting with the communication network 130 through the communication 182 using a second protocol, a response time measurement notification section 152 that measures a response time that is the period from when a request message is transmitted until a response message is received and informs the communication quality analysis server 120 of the response time together with a route that is used for the communication, a routing information acquisition section 153 that acquires a routing information item by transmitting an echo-request message, which is set to time out before reaching the server device 110, to the server device 110, receiving an echo-response message indicating the time-out of the echo-request message from one of the relay devices 131 to 135 on a route, and acquiring the address of the one of the relay devices 131 to 135, a protocol selection section 155 that selects, when the protocol selection section 155 is informed of one of the relay devices 131 to 135 that is determined as a delay element by the communication quality analysis server 120, one of the first transmitting/receiving section 151 that performs the communication 181 using the first protocol and the second transmitting/receiving section 154 that performs the communication 182 using the second protocol in order not to use the relay device. Note that, although not illustrated, the information acquisition apparatuses 141 to 143 have a configuration similar to that of the information acquisition apparatus 140.

FIG. 4 is a flowchart describing response time measurement notification processing S130 in the information acquisition apparatus 140. As illustrated in the flowchart, in the response time measurement notification processing S130, first, a request message for requesting connection is transmitted to the server device 110, after that, a response to the request message is received from the server device 110, and a response time in this case is measured (S131). Next, it is checked whether or not there is an information item regarding the communication route that is used at the time of measuring the response time (S132), and in the case where there is no routing information item, which is the information item regarding the communication route, the routing information item is acquired (S133). The acquisition of the routing information item is performed by, for example, transmitting an echo-request message, which is set to time out before reaching the server device 110, to the server device 110, receiving an echo-response message indicating the time-out of the echo-request message from one of the relay devices 131 to 135 on a route, and acquiring the address of the one of the relay devices 131 to 135. In this case, the addresses of the relay devices 131 to 135 may be sequentially acquired by receiving response messages while gradually increasing or decreasing the time taken for the echo-request message to time out. In the case where there is the routing information item in S132, or after the routing information item has been acquired, the routing information item and the response time are transmitted to the communication quality analysis server 120 (S134), and the response time measurement notification processing S130 is exited.

FIG. 5 shows MAC addresses of the information acquisition apparatuses 140 to 143 illustrated in FIG. 1, and FIG. 6 shows the specific contents of data items that are acquired and transmitted in the response time measurement notification processing S130 illustrated in FIG. 4. As shown in the table of FIG. 6, the data items that are transmitted to the communication quality analysis server 120 includes a routing information item, a response time, the MAC address of one of the information acquisition apparatuses 140 to 143 that has acquired the information item and a measurement time.

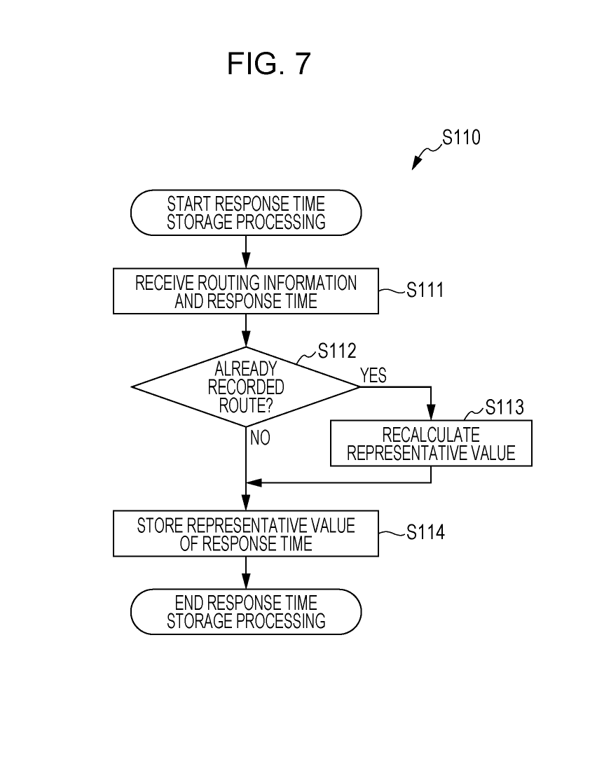

FIG. 7 is a flowchart describing response time storage processing S110 in the communication quality analysis server 120. As illustrated in the flowchart, in the response time storage processing S110, first, a routing information item, a response time, and the like are received from the information acquisition apparatus 140 (S111), and it is checked whether or not the routing information item is a route that has already been recorded in the response time memory 124 (S112). In the case where the routing information item is a route that has been already recorded, the average value of multiple response times that correspond to the route and that have been recorded is recalculated by including the received response time (S113), and the average value, which has been recalculated, is stored in the response time memory 124 as the representative value of the route (S114). On the other hand, in the case where the routing information item is a route that has not been recorded, the received response time is stored in the response time memory 124 as the representative value (S114). Note that the response time storage processing S110 is not necessarily performed each time a routing information item and a response time are received and may be performed when these information items are accumulated. In this case and in other cases, the response time storage processing S110 may be performed without transmission of a route to be measured (S111).

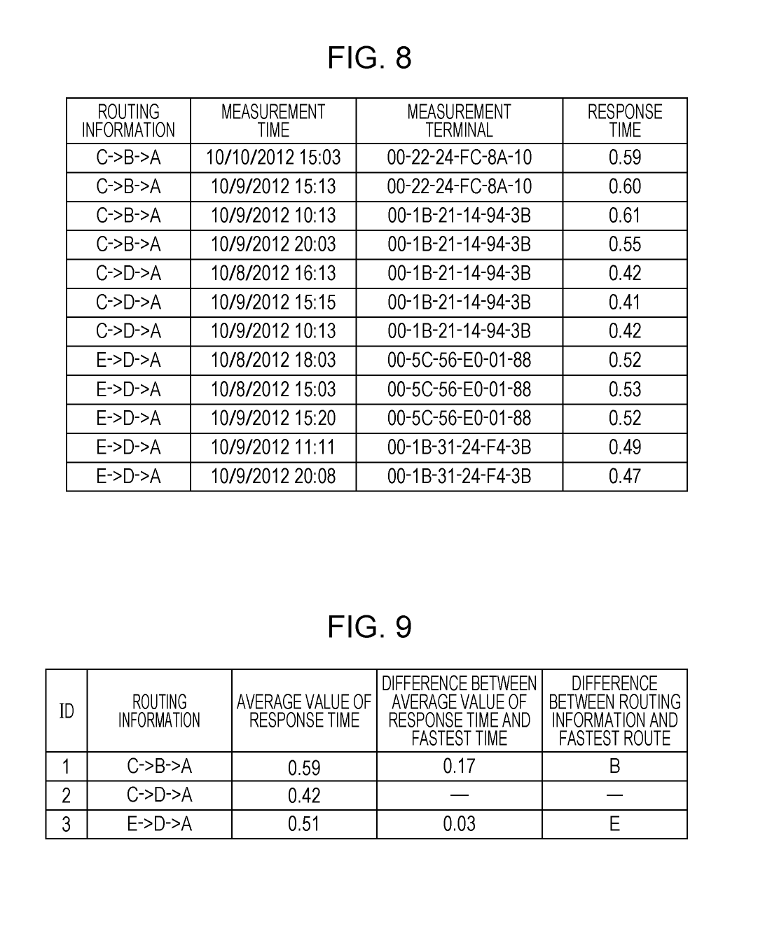

FIG. 8 shows response times that are data items, which are recorded in the response time memory 124, and that correspond to specific routing information items that are measured by the information acquisition apparatuses 140 to 143. As shown in the table, information items that are transmitted from the information acquisition apparatuses 140 to 143 are recorded in the response time memory 124. Similarly to FIG. 8, FIG. 9 shows data items which are recorded in the response time memory 124 and each of which is the average value of response times having the same routing information in FIG. 8 and each of which is the representative value that is stored in the response time storage processing S110 of FIG. 7. As illustrated in the table, the average values of response times of the routes from the information acquisition apparatuses 140 to 143 to the server device 110 illustrated in FIG. 1 are stored.

Note that, although in the exemplary embodiment, the average values of all the values that are recorded in the table of FIG. 8 are the representative values, only predetermined multiple measured values that have most recently been measured may be subjected to averaging. In addition, each of the representative values is not limited to an average value and may be the last single measured value or may be a value on which other statistical processing has been performed and which objectively shows response times.

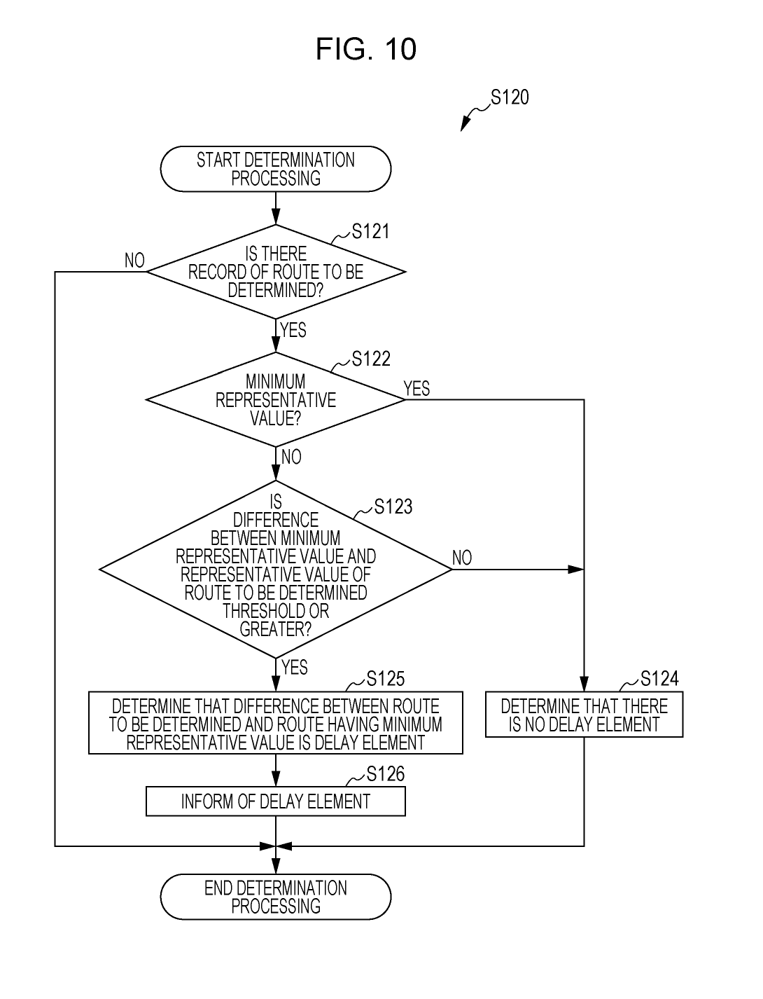

FIG. 10 is a flowchart describing determination processing S120 in the communication quality analysis server 120. The determination processing S120 may be performed on a route that is specified by an instruction from a user, an administrator of a network, or the like or may be performed on one or multiple last routes that are stored after the response time storage processing S110 of FIG. 7 is exited. As illustrated in the flowchart, in the determination processing S120, first, it is checked whether or not there is a record regarding a route to be determined, which is specified, in the response time memory 124 (S121). In the case where there is not a record, the determination processing S120 is exited. In the case where there is a record, it is determined whether or not the representative value of response times of the route to be determined is a minimum representative value, that is, the fastest average response time compared with those of other routes (S122). In the case where the representative value is a minimum representative value, it is determined that there is no delay element (S124), and the determination processing S120 is exited. In the case where the representative value is not a minimum representative value, a minimum representative value and the representative value to be determined are compared in such a manner as to determine whether or not a difference between the minimum representative value and the representative value to be determined is equal to or greater than a threshold (S123). In the case where it is not determined that the difference between the minimum representative value and the representative value to be determined is equal to or greater than the threshold, it is determined that there is no delay element (S124), and the determination processing S120 is exited. In the case where it is determined that the difference between the minimum representative value and the representative value to be determined is equal to or greater than the threshold, a difference between the routes is determined as a delay element (S125).

For example, in the table of FIG. 9, a representative value that is the average value of response times of a route C->B->A is 0.59 seconds, and a minimum representative value is 0.42 seconds for a route C->D->A. A difference between these representative values is 0.17 seconds. Here, in the case where a threshold is 0.15 seconds, the difference is greater than the threshold. Therefore, the relay device 133 that is B, which is a difference between the route C->B->A and the route C->D->A, is determined as a delay element. Note that in the case where a difference between routes indicates multiple relay devices and the like, it may be determined that a cause of a delay is present in a range in which the multiple relay devices are included.

In the case where there is a determined delay element, and if necessary, an administrator or a user who has requested the determination processing S120, a relay device capable of addressing the delay element, the information acquisition apparatuses 140 to 143, and the like may be informed of the delay element (S126). After notification of a delay element is performed, the determination processing S120 is exited. Note that notification of a delay element (S126) is not necessarily performed.

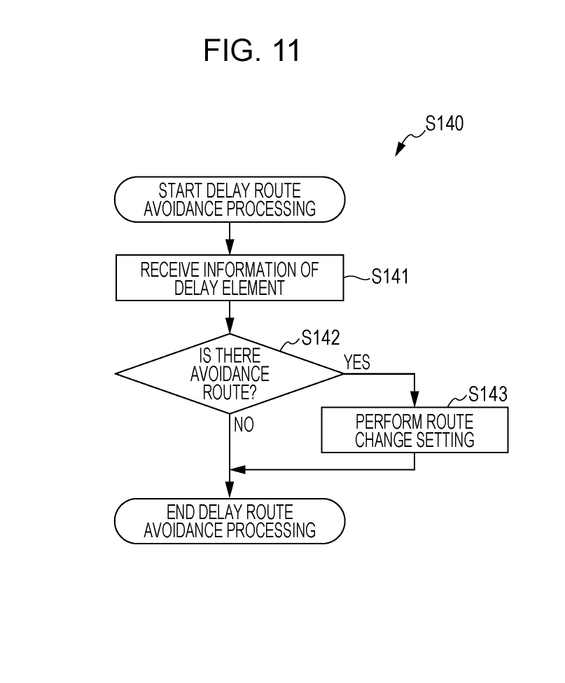

FIG. 11 is a flowchart illustrating delay route avoidance processing S140 that is an example of processing in the relay device 134 that is informed of a delay element. As illustrated in the flowchart, in the delay route avoidance processing S140, first, an information item regarding a delay element is received (S141), and it is determined from the information item regarding the delay element whether or not there is a route that may avoid the delay element owing to the relay device 134 (S142). In the case where it is determined that there is no avoidance route that may be set by the relay device 134, the delay route avoidance processing S140 is exited. On the other hand, in the case where it is determined that there is an avoidance route that may be set by the relay device 134, a route change setting operation is performed (S143), and the delay route avoidance processing S140 is exited. For example, in FIG. 1, the relay device 134 is informed of an information item regarding the relay device 133, which is a delay element, and the relay device 134 may stop using a route that passes through the relay device 133, which is a delay element, and select an avoidance route that passes through the relay device 132.

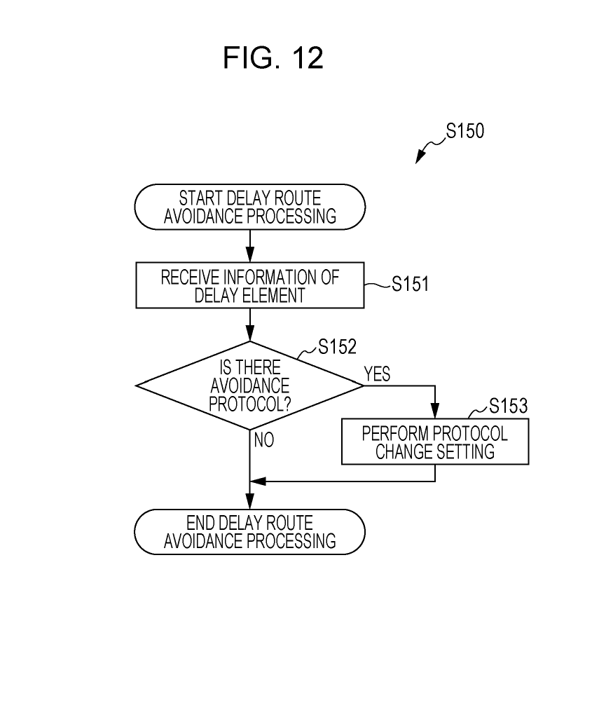

FIG. 12 is a flowchart illustrating delay route avoidance processing S150 that is an example of processing in the information acquisition apparatus 140 that is informed of a delay element. As illustrated in the flowchart, in the delay route avoidance processing S150, first, an information item regarding a delay element is received (S151), it is determined from the information item regarding the delay element whether or not there is a communication unit that uses other protocols that may avoid the delay element (S152). In the case where it is determined that there is no other avoidance protocol that may be set by the information acquisition apparatus 140, the delay route avoidance processing S150 is exited. On the other hand, in the case where it is determined that there is an avoidance protocol that may be set by the information acquisition apparatus 140, a protocol that avoids the delay element is selected (S153), and the delay route avoidance processing S150 is exited. For example, in FIG. 1, the information acquisition apparatus 140 is informed of an information item regarding the relay device 133, which is a delay element, and the information acquisition apparatus 140 may perform setting for switching the communication 181, which uses the first protocol and which is performed by using the first transmitting/receiving section 151, to the communication 182, which uses the second protocol and which is performed by using the second transmitting/receiving section 154.

As described above, in the exemplary embodiment, communication speeds in various routes on a network may be evaluated. In addition, one or multiple relay devices that cause a delay may be determined.

Note that the configuration of the information processing system 100 of the exemplary embodiment is an example of exemplary embodiments of the invention, and the technical concept and minimal configuration of the information processing system according to the exemplary embodiments of the invention will be set forth in the claims.

In the above-described exemplary embodiment, a program that performs processing may be stored in an internal memory such as a magnetic disk unit or may be provided by being stored in other storage media such as a compact disc read-only memory (CD-ROM).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A communication device comprising:
a memory in which representative values are stored, each of the representative values being a representative value of response times of communication with a server using one of a plurality of routes in a communication line that has the plurality of routes, which include a plurality of relay devices and which are used to access the server, and the representative values being related to at least two of the routes; and
a determining section that determines that, in the case where a difference between the representative values, which are related to the two different routes and which are stored in the memory, is greater than a threshold, one of the relay devices that is a difference between configurations of the two different routes is a delay element.

2. A communication device comprising:
a response time memory in which representative values are stored, each of the representative values being a representative value of response times of communication with a server device using one of a plurality of routes in communication with the server device using a network that has the plurality of routes, which are used to access the server device, as a result of arranging a plurality of relay devices, and the representative values being related to at least two of the routes; and
a determining section that determines that, in the case where a difference between the representative values of the response times, which are related to the two different routes and which are stored in the response time memory, is greater than a threshold, and in the case where one of the relay devices that is a difference between configurations of the two different routes is present, the relay device that is the difference is a delay element.

3. The communication device according to claim 2, further comprising:
a response time storage section that recalculates, in the case where a route that relates to a response time that is measured is one of the routes that have already been stored in the response time memory, a representative value that relates to the route, which has been stored, by using the response times that are stored in the response time memory and stores the representative value in the response time memory, and in the case where a route that relates to the response time is a route that is not stored, adds the route, which is not stored, as the route and stores the response time in the response time memory as a representative value of response times of communication with the server device using the route that is added.

4. The communication device according to claim 2,
wherein the two different routes are one route that is subjected to the determination and a route that has a minimum representative value that is recorded in the response time memory, and
wherein, in the case where the one route is the route that has the minimum representative value, which is recorded in the response time memory, it is determined that there is no delay element.

5. The communication device according to claim 2,
wherein each of the representative values is an average value of the plurality of response times that are obtained as a result of a plurality of latest measurements.

6. An information processing system comprising:
a response time memory in which representative values are stored, each of the representative values being a representative value of response times of communication with a server device using one of a plurality of routes in communication with the server device using a network that has the plurality of routes, which are used to access the server device, as a result of arranging a plurality of relay devices, and the representative values being related to at least two of the routes; and
a determining section that determines that, in the case where a difference between the representative values of the response times, which are related to the two different routes and which are stored in the response time memory, is greater than a threshold, and in the case where one of the relay devices that is a difference between configurations of the two different routes is present, the relay device that is the difference is a delay element.

7. The information processing system according to claim 6, further comprising:
a response time storage section that recalculates, in the case where a route that relates to a response time that is measured is one of the routes that have already been stored in the response time memory, a representative value that relates to the route, which has been stored, by using the response times that are stored in the response time memory and stores the representative value in the response time memory, and in the case where a route that relates to the response time is a route that is not stored, adds the route, which is not stored, as the route and stores the response time in the response time memory as a representative value of response times of communication with the server device using the route that is added.

8. The information processing system according to claim 6,
wherein the two different routes are one route that is subjected to the determination and a route that has a minimum representative value that is recorded in the response time memory, and
wherein, in the case where the one route is the route that has the minimum representative value, which is recorded in the response time memory, it is determined that there is no delay element.

9. The information processing system according to claim 6,
wherein each of the representative values is an average value of the plurality of response times that are obtained as a result of a plurality of latest measurements.

10. The information processing system according to claim 6, further comprising:
an information acquisition section that is connected to the network and forms the routes between the server device and the information acquisition section,
wherein the information acquisition section includes
a transmitting/receiving section that transmits a request message for requesting connection to the server device and receives a response message to the request message from the server device, and
a response time measurement notification section that measures a response time that is a period from the transmission until the reception and informs an apparatus that has the response time memory of the response time that is measured and a route of transmission and reception performed between the server device and the transmitting/receiving section.

11. The information processing system according to claim 10,
wherein the information acquisition section further includes a routing information acquisition section that acquires an information item of the route of transmission and reception performed between the server device and the information acquisition section by transmitting an echo-request message that times out before reaching the server device to the server device, receiving an echo-response message indicating the time-out of the echo-request message from one of the relay devices on the route, and acquiring an address of the one of the relay devices.

12. The information processing system according to claim 10,
wherein the information acquisition section further includes a protocol selection section that receives an information item regarding the delay element and allows communication using a different protocol that does not use the relay device, which is determined as the delay element, in the case of an access to the server device.

13. The information processing system according to claim 6, further comprising:
a relay device that receives an information item regarding the delay element and that selects a route that does not use the relay device that is determined as the delay element.

14. A non-transitory computer readable medium storing a program causing a computer to execute a process comprising:
causing a memory to record representative values each of which is a representative value of response times of communication with a server device using one of a plurality of routes in communication with the server device using a network that has the plurality of routes, which are used to access the server device, as a result of arranging a plurality of relay devices, the representative values being related to at least two of the routes; and
determining that, in the case where a difference between the representative values of the response times, which are related to the two different routes and which are stored, is greater than a threshold, and in the case where one of the relay devices that is a difference between configurations of the two different routes is present, the relay device that is the difference is a delay element.
